(19) United States
(12) Patent Application Publication
(10) Pub. No.: US 2025/0320664 A1
(43) Pub. Date: Oct. 16, 2025

(54) ULTRATHIN AND UNIFORM BARRIER LAYER FOR COATED CELLULOSIC STRUCTURES

(71) Applicant: WestRock MWV, LLC, Atlanta, GA (US)

(72) Inventors: Mohammadtaghi SAVOJI, Atlanta, GA (US); Malik Anson BELL, Atlanta, GA (US); Jiebin PANG, Glen Allen, VA (US)

(21) Appl. No.: 19/050,716

(22) Filed: Feb. 11, 2025

Related U.S. Application Data
(60) Provisional application No. 63/552,970, filed on Feb. 13, 2024.

(51) Int. Cl. D21H 19/82; B05D 1/28; B05D 3/02; D21H 19/38; D21H 19/40; D21H 19/62; D21H 19/72

(52) U.S. Cl. CPC D21H 19/822; B05D 1/28; B05D 3/0254; D21H 19/385; D21H 19/40; D21H 19/62; D21H 19/72; B05D 2203/22; B05D 2401/20

(57) ABSTRACT

A coated cellulosic structure includes a cellulosic sheet substrate, a basecoat layer on the cellulosic sheet substrate, and a barrier layer on the basecoat layer. The barrier layer has an average thickness (AT) in a range of from about 1 μm to about 6 μm. The barrier layer has a uniformity in thickness characterized by a coefficient of variation (CV) of 0.7 or less, wherein CV=σ/AT, wherein σ is the standard deviation of the thickness.

### FIELD

The present description pertains to the field of materials science and engineering, specifically to the development and application of coatings for cellulosic structures. It focuses on techniques for enhancing barrier properties in cellulosic materials, such as paper and cardboard, commonly used in packaging and other industrial applications.

### BACKGROUND

Traditionally, cellulosic structures have been widely used in various industries, notably in packaging, due to their versatility and sustainability. However, enhancing their barrier properties against moisture, oil, and other environmental factors has been a persistent challenge. The conventional methods often involve applying various coatings to improve these properties, but achieving a balance between effective barrier performance and maintaining the physical integrity and environmental benefits of cellulosic materials can be complex. Moreover, the existing coating processes, particularly those carried out away from the primary manufacturing line, add complexity and cost. These offline coating methods necessitate additional steps, handling, and equipment, which not only increase production costs but also impact the overall efficiency of the manufacturing process. There is a need for a more streamlined and cost-effective approach to applying barrier coatings without compromising the quality and sustainability of cellulosic materials.

### SUMMARY

The patent application details a coated cellulosic structure and a method for its manufacture. An exemplary structure is defined by a cellulosic sheet substrate, a basecoat layer, and a barrier layer, where the barrier layer has thinness and uniformity. An exemplary manufacturing method involves preparing the cellulosic sheet substrate including a basecoat, which may be applied on paper machine during the paper manufacturing process, and then applying a barrier layer, which may be applied on a printing press. This application process can include transferring the barrier material through a series of rollers, followed by a drying step at a specific temperature.

In a specific example of the present description, there is a coated cellulosic structure, comprising: a cellulosic sheet substrate; a basecoat layer on the cellulosic sheet substrate; and a barrier layer on the basecoat layer, wherein the barrier layer has an average thickness (AT) in a range of from about 1 μm to about 6 μm, and wherein the barrier layer has a uniformity in thickness characterized by a coefficient of variation (CV) of 0.7 or less, wherein CV=σ/AT, wherein a is the standard deviation of the thickness.

In another specific example of the present description, there is a method for applying a barrier layer to a base coated cellulosic structure, the method comprising: transferring a barrier material to a roller having cells for holding a predetermined volume of the barrier material; transferring the barrier material from the roller having cells to a transfer roller; applying the barrier material from the transfer roller to a basecoat layer on a cellulosic sheet substrate to form a barrier layer; and drying the applied barrier layer at a drying temperature of 200 degrees F. or greater for a time sufficient to reach web surface temperature of 120 F or higher.

In another specific example of the present description, there is a method for applying multiple barrier layers to the base-coated cellulosic structure, the method comprising: applying multiple (e.g., two) layers of barrier coating on the base coated cellulosic structure. Applying the barrier layer comprises transferring a barrier material to a roller having cells for holding a predetermined volume of the barrier material; transferring the barrier material from the roller having cells to a transfer roller; applying the barrier material from the transfer roller to the basecoat layer to form a barrier layer; and drying the applied barrier layer at a drying temperature of 200 degrees F. or greater for a time sufficient to reach a web surface temperature of 120 F or higher.

### BRIEF DESCRIPTION OF THE DRAWINGS

FIG. 1: Cross-sectional view of the coated cellulosic structure, showing the cellulosic sheet substrate, the basecoat layer, and the barrier layer.

FIG. 2: Schematic of the flexographic printing machine used in the method, illustrating the arrangement of rollers and drying stations.

FIG. 3: Detailed view of a printing station within the flexographic printing machine, highlighting components such as the anilox roller and transfer roller.

FIG. 4: SEM image of a successful barrier coating using the method with extended heat.

FIG. 5: SEM image of a different sample with successful barrier coating using the method with extended heat.

FIG. 6: SEM image of another sample with successful barrier coating using the method with extended heat.

FIG. 7: SEM image of yet another sample with successful barrier coating using the method with extended heat.

FIG. 8: SEM image showing the comparative example without extended heat, highlighting the lack of uniform coating.

### DETAILED DESCRIPTION

The following detailed description presents various embodiments of the invention, providing a clear understanding of its features and functionalities. The embodiments are described to illustrate the invention's broad applicability and should not be construed as limiting in any manner. The scope of the invention is defined by the appended claims, and all changes that come within the meaning and range of equivalency are to be embraced within their scope.

### 1. INTRODUCTION

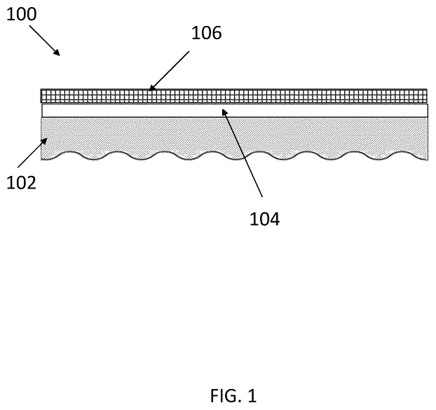

The present disclosure pertains to a coated cellulosic structure, alongside methodologies for its fabrication. It emphasizes the production of a cellulosic structure with superior barrier properties, applicable across various applications. The structure, as illustrated in FIG. 1, is delineated by a cellulosic sheet substrate (102), a basecoat layer (104) applied onto this substrate, and an ultrathin barrier layer (106) atop the basecoat. The disclosed invention particularly focuses on the barrier layer's characteristics, notably its thickness and uniformity, with the barrier layer having an average thickness (AT) in a range of about 1 μm to about 6 μm, and a uniformity in thickness characterized by a coefficient of variation (CV) of 0.7 or less, where CV=σ/AT and σ is the standard deviation of the thickness. It is important to note that FIG. 1 is merely an illustrative representation, and the actual thickness and CV of the layers may not be accurately depicted in the figure.

Following sections provide an in-depth discussion on how each element of the coated cellulosic structure contributes to its overall function. The detailed description covers the specific compositions, structures, and application methods for the cellulosic sheet substrate including the basecoat layer, and the ultrathin barrier layer. Additionally, it elaborates on steps in the application process, such as anilox roller loading, transfer of barrier material, and controlled drying at high temperatures, resulting in a product that embodies the improved properties. These attributes include, but are not limited to, improved moisture resistance, especially moisture vapor barrier, and consistent coating quality.

### 2. CELLULOSIC SHEET SUBSTRATE

### 2.1 Purpose of the Cellulosic Sheet Substrate

The cellulosic sheet substrate, particularly when paperboard is used, forms the foundational layer of the coated structure. It offers essential structural support and a suitable surface for subsequent coating layers. The properties of the substrate, including porosity and surface roughness, are conducive to various industrial processes and enhance the application and performance of additional coatings.

### 2.2 Structural Composition and Properties

The substrate is primarily composed of cellulose fibers, which may include bleached, natural kraft, or recycled fibers. The type of fiber selected can influence the substrate's appearance and physical properties. The substrate can be single layer or multi-layer.

The thickness of the paperboard substrate is an important characteristic and typically ranges from about 6 to about 36 points. Within this range, various sub-ranges are selected based on specific application requirements. For instance, a range of 8 to 12 points may be preferred for applications requiring flexibility and durability, 12 to 26 points for packaging applications needing greater strength, and 26 to 36 points for applications where high rigidity is essential.

### 2.3 Method of Formation

Various methods can be employed to produce the cellulosic sheet substrate. A common method involves a traditional papermaking process, including pulping, sheet formation, pressing, and drying. This process is particularly influential in determining the substrate's surface characteristics. Adjustments in temperature and humidity during the drying stage can tailor the surface properties, such as porosity or smoothness, which affect the substrate's ability to receive and retain subsequent coatings. However, this traditional papermaking process is presented as one example, and alternative methods known in the art of paper and paperboard manufacturing are also applicable.

The flexibility in the method of formation allows for a wide variety of cellulosic sheet substrates to be used in the coated structure, accommodating different industrial needs and consumer preferences. The choice of production method may be guided by factors such as the desired physical properties, environmental considerations, and specific end-use requirements of the substrate.

### 3. BASECOAT LAYER

### 3.1 Purpose of the Basecoat Layer

The basecoat layer, when applied to the cellulosic sheet substrate, serves to fill in surface porosity, thus creating a more uniform and level surface. This uniformity is important for the effective application of the barrier layer, as it ensures consistent coating for optimal barrier properties. Additionally, the basecoat contributes to the overall structural integrity of the final product and may enhance certain barrier characteristics.

### 3.2 Structural Composition and Properties

The basecoat typically includes an aqueous-based formulation with binders and pigments. Binders, which may be latex or other polymer emulsions, help in adhering to the substrate and form a continuous film upon drying. Pigments, such as clay, calcium carbonate, or other cost-effective alternatives, assist in pore filling and achieving surface smoothness and opacity.

The ratio of binder to pigment in the basecoat can vary. Ratios commonly range from about 12 to about 50 parts binder to 100 parts pigment. Within this range, sub-ranges such as 15 to 45 parts binder, or 20 to 40 parts binder per 100 parts pigment, may be selected based on specific property requirements. A higher binder ratio may be chosen for improved film formation and surface leveling, while a lower ratio might be selected for cost-effectiveness and repulpability or recyclability.

The application of multiple layers of basecoat material allows for adjustments in the final properties of the coated substrate, with each layer contributing cumulatively to overall property and barrier enhancement.

### 3.3 Method of Application

The basecoat can be applied using various conventional coating techniques on a paper machine or on an off-line coater. These methods include roll coating, blade coating, or curtain coating, selected based on factors like the required thickness of the basecoat, the properties of the basecoat formulation, and the characteristics of the cellulosic sheet substrate. Achieving even coverage is important for uniform leveling.

The drying process of the basecoat involves the controlled application of heated air or infrared drying methods to remove water content and solidify the coat. This step ensures the basecoat adheres properly to the substrate and prepares it for the subsequent application of the barrier layer.

The goal, whether using a single or multiple layers of basecoat, is to enhance the surface characteristics of the cellulosic substrate effectively, thereby supporting the coated structure's overall functionality.

### 4. ULTRATHIN BARRIER LAYER

### 4.1 Purpose of the Barrier Layer

The barrier layer, applied over the basecoat on the cellulosic sheet substrate, is designed to enhance the structure's resistance to environmental factors, such as moisture or moisture vapor. This layer acts as a protective shield and contributes significantly to the overall effectiveness and durability of the coated cellulosic material.

### 4.2 Structural Composition and Properties

The barrier layer generally comprises an aqueous-based material, often including a polymer latex, a polymer dispersion, a polymer emulsion, or similar polymer dispersions. These materials are chosen for their ability to form a continuous, uniform film upon drying, which is essential for the barrier layer's effectiveness. To augment the barrier properties and enhance the physical characteristics of the layer, pigments such as clay, calcium carbonate, or their combinations can be incorporated. These pigments can serve multiple purposes, contributing to the opacity, mechanical strength, and printability of the surface, while also potentially modifying the barrier properties.

If pigment is included in the barrier layer, the proportion of binder to pigment can be expressed in a ratio that ranges from about 150 to about 900 parts binder per 100 parts pigment. Within this range, specific sub-ranges can delineated to modify the coating's properties to particular applications. For instance, a ratio in the lower end of the range (approximately 150 to 300 parts binder) might be preferred for applications requiring a moderate barrier level and a high flexibility is not required. Conversely, a higher ratio (approximately 600 to 900 parts binder) could be selected for applications requiring a higher degree of flexibility and a higher level of barrier. A ratio in the range of 300 parts binder to 600 parts binder may be used to balance flexibility with the beneficial effects of the pigments.

The thickness of the barrier layer is a notable aspect of its design. The average thickness (AT) typically ranges from about 0.5 μm to about 6 μm, with sub-ranges selected based on the specific requirements of the application. These sub-ranges include from about 1 μm to about 5 μm, more preferably from about 1.5 μm to about 4 μm, and most preferably from about 2 μm to about 3 μm. Selecting a particular thickness within these ranges may be influenced by a balance between achieving effective barrier properties and environmental considerations. The barrier layer may be applied as a single layer, as two layer or as more than two layers.

### 4.3 Uniformity and Measurement

Uniformity in the thickness of the barrier layer is a significant aspect of the layer's quality. The coefficient of variation (CV) is used as a measure of this uniformity, with a target to maintain the CV at 0.7 or less, more preferably at 0.6 or less, and most preferably at 0.5 or less. The CV, being the ratio of the standard deviation (a) to the mean (AT), provides a statistical measure of the relative variability in thickness. This uniformity is an important aspect of the invention, as it enables the use of a lower thickness coating while still maintaining effective barrier properties.

The determination of average thickness (AT) involves measuring the thickness at various points across the barrier layer and calculating the mean. This measurement approach ensures that the barrier layer's uniformity is accurately assessed, contributing to the overall quality and effectiveness of the coated cellulosic material. The high uniformity allows for the minimization of material usage while still achieving the desired barrier properties, aligning with environmental sustainability goals.

An innovative aspect of the barrier layer lies in achieving and maintaining this high degree of uniformity in thickness. This uniformity ensures that even at lower thicknesses, the barrier layer remains effective in protecting against moisture and other environmental factors. The ability to apply a barrier layer that is both ultrathin and uniformly distributed across the substrate represents a significant advancement in the field of coated cellulosic materials.

### 5. METHOD OF APPLYING THE BARRIER LAYER

### 5.1 Anilox Roller Preparation and Loading

An anilox roller features a series of cells that hold a precise volume of barrier material, important for delivering a uniform application. These cells are typically created through an engraving process, which defines their volume. The structure and function of the anilox roller facilitate the consistent transfer of barrier material to the transfer roller. The roller is loaded with barrier material using any standard method that allows for precision loading. A common method includes the use of a metering roller and a blade system, but other effective techniques are also within the scope of the invention.

### 5.2 Transfer Roller Application

After the anilox roller, the barrier material is transferred to a transfer roller. The transfer roller's surface is smooth and designed to receive the barrier material from the anilox roller, ensuring an even application to the basecoat. The material of the transfer roller is selected based on its receptivity to the barrier material and its contribution to a uniform transfer process. In an example, the transfer roller can comprise a photopolymer rubber or a uniform rubber sleeve.

### 5.3 Application of Barrier Material to Basecoat

The barrier material is applied from the transfer roller to the basecoat layer, with pressure adjusted to ensure even distribution of the material. This results in a uniform barrier layer across the basecoat, with consistent thickness and barrier properties.

### 5.4 Implementation of Flexographic Printing in the Application Process

In this specific example, the application of the barrier material to the cellulosic structure can be executed using flexographic printing technology, traditionally used for patterned ink applications. This technology is adapted to uniformly apply the barrier layer. The flexographic printing system incorporates the anilox roller, the transfer roller, and the direct application of the material to the basecoat on the substrate, as previously described.

The flexographic printing process can include multiple stations within the press, each playing a role in the application of the barrier material. The anilox roller, designed to hold and transfer the barrier material with precision, conveys the material to the transfer roller. This roller then uniformly applies the material to the basecoat layer of the cellulosic sheet substrate. The use of multiple stations in the press facilitates the successive application of one or more layers of barrier material. Each additional layer contributes to the overall barrier properties of the final product. This approach demonstrates how the various components and stages of the process synergize in a practical application, ensuring consistency and uniformity in the barrier layer of the coated cellulosic structure.

### 5.5 Drying Process for Uniform Barrier Layer

The drying process is a decisive factor in the application of the barrier layer. Unlike conventional flexographic printing where ink is applied in small, discrete amounts and dries quickly at temperatures well below 200 degrees Fahrenheit, the barrier layer in this invention requires a different approach to achieve uniformity.

Drying at Elevated Temperatures: In traditional flexographic systems, drying typically occurs in dryers at below 200 degrees Fahrenheit due to the minimal volume of ink applied. However, for the uniform barrier layer of this invention, the drying process requires elevated temperatures, extending beyond the range used in standard practices. To ensure that the barrier material, including latex dispersions, dries effectively without significant undispersion or clumping, the process employs temperatures of 200 degrees Fahrenheit or greater for a time sufficient to achieve a web surface temperature of 120 degrees Fahrenheit or higher. Based on experimental examples and practical considerations, a dryer temperature range from 200 degrees Fahrenheit to 350 degrees Fahrenheit is established as a practical range that is both effective to reach web temperature of 120 degrees Fahrenheit or higher for uniformly drying and safe for heating coated paperboard. Sub-ranges include from about 250 degrees Fahrenheit to about 300 degrees Fahrenheit, directly informed by the experimental examples. Additionally, individual sub-ranges are specified, such as from about 225 degrees Fahrenheit to about 275 degrees Fahrenheit and from about 275 degrees Fahrenheit to about 325 degrees Fahrenheit, which include both the 250 and 300 degrees Fahrenheit benchmarks for the experimental example. These temperature sub-ranges are selected to ensure optimal drying of the barrier material, thereby maintaining the uniformity of the barrier layer. The effect of employing higher or lower temperatures within these ranges can have multiple effects. Higher temperatures facilitate faster drying and forming a uniform film by the barrier material, which is advantageous for increasing production efficiency. Excessively high temperatures, while speeding up the process, may lead to other issues such as, potentially, warping of the substrate, potential degradation of the barrier material or basecoat material, or uneven drying, where the surface dries too quickly, trapping moisture underneath. Therefore, the chosen temperature range aims to optimize the drying rate without compromising the integrity of the cellulosic structure and uniformity of the barrier layer. This balance ensures that the drying process contributes to the overall effectiveness and durability of the coated cellulosic structure, aligning with the goals of uniformity and efficiency in the production process.

Modification of Flexographic Printing Systems: To implement this drying process, a typical flexographic printing system can be modified to include an extended heating section. This modification allows the barrier material to dry during its passage through the heating section, despite the short duration, which could be 2 seconds or greater, or 6 seconds or greater, or 10 seconds or greater. The focus on surface temperature of the coated cellulosic structure, rather than time, is significant given the brief exposure of the material to the drying conditions. The duration of time may vary depending on the temperature of heating and the amount of barrier material applied.

Theory Behind Temperature Selection: Although the invention is not limited by theory, it is believed that the effect of high temperature drying relates to the behavior of the latex dispersion upon application. At lower temperatures, as demonstrated in the comparative example drying at 180 degrees Fahrenheit, the latex has the propensity to locally collapse, leading to uneven coverage and uncoated portions. Conversely, when the drying temperature exceeds 200 degrees Fahrenheit and the web surface temperature reaches 120 degrees Fahrenheit or greater, the latex or other barrier material will spread through the surface, preserving the uniformity established by the precise application from the anilox and transfer rollers. This phenomenon is supported by the structure of the anilox roller itself, which, due to its hundreds of cells per linear inch, assists in the even distribution of the barrier material, reducing the tendency for clumping or undispersion during the drying phase.

### 6. ADDITIONAL FEATURES AND ADVANTAGES OF THE INVENTION

### 6.1 General Purpose and Problem Solved

The invention's primary aim is to develop a paperboard with enhanced barrier properties, specifically targeting a Water Vapor Transmission Rate (WVTR) of less than 400 gsm/day at 38° C. and 90% RH, and an Oil and Grease Resistance (OGR) Kit level of 12. This addresses the need for more effective barrier properties in paperboard materials. The target WVTR ranges cater to specific commercial needs, such as <400 gsm/day for primarily OGR-focused applications, 100-200 gsm/day for bakery products, and <100 gsm/day for high water barrier applications like frozen food packaging.

### 6.2 Advantages

The invention offers significant benefits, including substantially improved WVTR and OGR barrier properties, achieved through extended heat or curing with aqueous barrier coatings. It also provides cost-saving opportunities by enabling inline printing and using low coat weight materials.

### 6.3 Commercial Applications

This invention has a broad range of applications, making it suitable for diverse packaging needs. Beyond its evident use in consumer packaging for frozen foods, bakery products, and Quick Service Restaurants (QSR), the enhanced barrier properties of this paperboard make it applicable in areas like dry food packaging, pharmaceuticals, cosmetics, and electronic goods packaging. The versatility of the product extends to specialty packaging solutions where moisture and oil resistance are essential, such as in the packaging of medical supplies or luxury items.

### 6.4 Enhancement of Existing Basecoated Paperboard

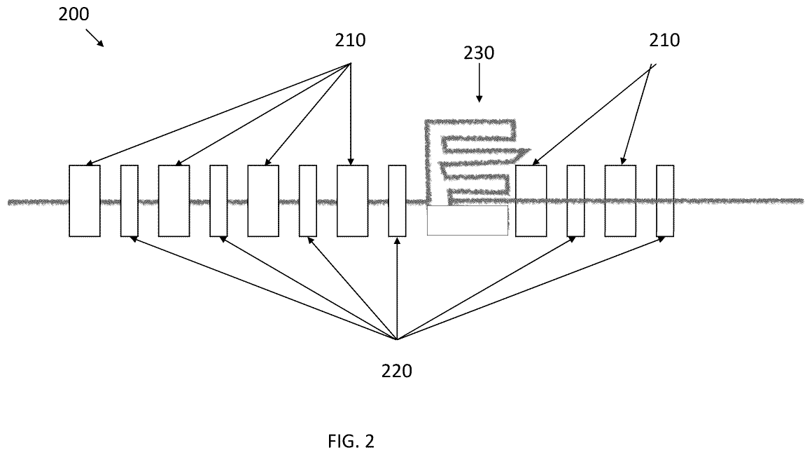

The innovation enhances commercial basecoated paperboard products like Enshield™ by Westrock by adding an ultrathin, uniform barrier layer that considerably improves the paperboard's barrier properties. The application of this barrier layer employs a flexographic printing machine, generically illustrated in FIG. 2, which outlines the machine (200) including its printing stations (210) and drying stations (220), with an extended heating section (230) bypassing one of the printing and drying stations.

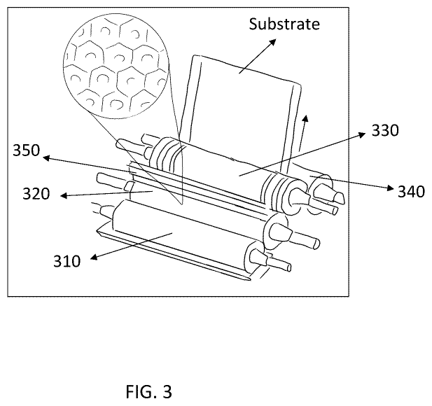

FIG. 3 provides an illustrative representation of an individual printing station (300) within the flexographic printing machine. This station includes a pickup roller (310) for the distribution of binder material, an anilox roller (320) with cells (322) that precisely meter the material, a rubber transfer roller (330), and an impression roller (340) for consistent application pressure. A blade (350) ensures the anilox roller is free from excess material. These figures are illustrative representations that do not replicate the exact configurations of the machine used in the experimental examples but provide a conceptual understanding of its functionality.

This approach's compatibility with continuous package-making operations means that the barrier coating can be applied in-line with the converting process, thereby streamlining production and improving efficiency. The in-line application also offers production speed and cost-effectiveness by allowing for the continuous and uniform application of the barrier layer.

By building on an established basecoated paperboard, this invention presents a practical and efficient method to enhance the barrier properties of paperboard materials, improving their functionality and broadening their application in diverse packaging industries.

### 7. EXPERIMENTAL EXAMPLES

### 7.1 Experimental Setup and Procedure

The experimental methodology incorporated an overhead extended heater within a 7-station flexographic printing process. The setup was designed to sequentially apply one or two layers of an aqueous barrier coating, with specific stations within the press being utilized for this purpose.

For the experiments, anilox rolls with volumes of 8 and 12 bcm (billion cubic micron) were used at designated stations to apply the barrier material. This selection was based on the desired coat weight and barrier properties. The system's configuration allowed the extended heat section, which operates at a temperature range of 200-300° F., to be placed at strategic locations along the production line for optimal curing.

In a detailed procedural example, the paperboard was first coated at one station and then passed through a drying process. A second coating may or may not be applied at another station and followed by passage through two low-temperature dryers set at 180° F. After these initial drying stages, the paperboard was directed to the extended heat dryer for additional curing.

The setup was adjusted so that after the second coating (if applicable) and drying, the paperboard bypassed a station to move directly to the extended heating section. The paperboard continued through the process, with the final station being used for printing identification marks for subsequent testing phases.

Once the printing and drying processes were completed, the paperboard was rewound. The finished product was then moved to a laboratory setting, where it was cut into sheets and assessed for barrier properties. This experimental setup was crucial for evaluating the performance enhancements provided by the barrier coatings.

### 7.2 Experimental Results

The results from the press-applied barrier coating trials are comprehensively documented in Tables 1 and 2, providing detailed data on the barrier properties and thickness measurements of the paperboard coated in the Pilot PAC Trials. The base-coated substrate used in the trials was 18 point, EnShield™, manufactured by WestRock. Most of the samples in Table 1 were coated with a single-layer barrier coating on a Flexo printing press, except for WPAC01 and WPAC03 that were coated with two layers of barrier coating.

TABLE 1
Barrier Properties of Paperboard:

| | | Extended Heat Set Temp | | Press Speed | Dwell time | Web Temp | | | |
|---|---|---|---|---|---|---|---|---|---|
| Pilot PAC Trial | ID | Temp (F.) | Temp (° C.) | (fpm) | (s) | Temp (F.) | Temp (° C.) | WVTR | 2-min Cobb |
| December 2022 | DA1 | 250 | 121 | 175 | 18 | 133 | 56 | 311 | 0.39 |
| | DA2 | 250 | 121 | 300 | 10 | 120 | 49 | 378 | 0.33 |
| | DB1 | 300 | 149 | 175 | 18 | 157 | 69 | 67 | 0.17 |
| | DB2 | 300 | 149 | 300 | 10 | 139 | 59 | 392 | 0.19 |
| May 2023 | MA1 | 250 | 121 | 100 | 31 | 158 | 70 | 240 | 8.4 |
| | MA2 | 250 | 121 | 200 | 16 | 158 | 70 | 210 | 6.2 |
| | MB1 | 300 | 149 | 100 | 31 | 180 | 82 | 205 | 8.0 |
| | MB3 | 300 | 149 | 300 | 10 | 171 | 77 | 188 | 4.3 |
| October 2023 | WPAC01 | 250 | 121 | 150 | 6 | 155 | 68 | 259 | 11.5 |
| | WPAC03 | 250 | 121 | 450 | 2 | 136 | 58 | 494 | 7.1 |

This table encapsulates outcomes from trials conducted in December 2022, May 2023, and October 2023, including:

Extended Heat Set Temperature: The temperature at which the extended heat section was set.

Press Speed (fpm): Operational speed of the press.

Dwell Time (s): Duration of the paperboard under extended heat.

Web Temperature: Post-processing temperature of the paperboard.

WVTR: Water Vapor Transmission Rate, assessed following the TAPPI T 464 standard.

2-min Cobb: Water absorbency measurement over two minutes, in accordance with the TAPPI T 441 standard.

TABLE 2
Barrier Thickness Measurements:

| Barrier Thickness Measurements in Microns | | | | | | | | |
|---|---|---|---|---|---|---|---|---|
| Sample ID | Average (μ) | STDev (σ) | Min | Max | Range | Sum | Count | CV (σ/μ) |
| DA1 | 2.8 | 1.3 | 1.2 | 6.3 | 5.1 | 579.6 | 204 | 0.46 |
| DA2 | 2.8 | 1.5 | 0.9 | 7.6 | 6.8 | 563.8 | 204 | 0.54 |
| DB1 | 3 | 1.8 | 1 | 7.7 | 6.7 | 604.5 | 204 | 0.60 |
| DB2 | 2.5 | 1 | 0.9 | 5.4 | 4.6 | 514.3 | 204 | 0.40 |
| MA1 | 2.4 | 1.1 | 0.9 | 5.3 | 4.4 | 469.5 | 199 | 0.46 |
| MA2 | 3 | 1.2 | 1 | 5.9 | 4.9 | 618.1 | 204 | 0.40 |
| MB1 | 3.1 | 1.6 | 0.8 | 6.6 | 5.8 | 638.6 | 204 | 0.52 |
| MB3 | 2 | 0.7 | 0.9 | 3.9 | 3 | 403.6 | 199 | 0.35 |
| WPAC01 | 2.1 | 0.6 | 0.9 | 3.5 | 2.7 | 428 | 204 | 0.29 |
| WPAC03 | 3 | 1.3 | 1.1 | 6.6 | 5.6 | 604.6 | 204 | 0.43 |

This table provides a quantitative analysis of barrier layer thickness, featuring:

Sample ID: Label for each trial sample.

Average Thickness (μ): Average thickness in microns.

Standard Deviation (σ): Variability in thickness.

Minimum and Maximum Thickness: Thickness range within each sample.

Range: Difference between minimum and maximum thickness.

Sum and Count: Total of thickness measurements and number of measurements.

CV (Coefficient of Variation): Standard deviation to mean thickness ratio, representing uniformity.

The experimental results from Tables 1 and 2 illustrate the successful application of the barrier layer under various conditions using elevated temperatures. In stark contrast, the comparative example, which was processed using a drying temperature of 180 degrees Fahrenheit, displaying significantly inferior results. This lower temperature was insufficient for proper curing, leading to the presence of bare spots where the barrier material failed to form a uniform film. Due to these defects, quantitative measurements for the comparative example were deemed not feasible, as the integrity of the barrier layer was compromised to a point where consistent data collection was not possible. This highlights the necessity of utilizing elevated temperatures to ensure complete coverage and uniformity of the barrier coating.

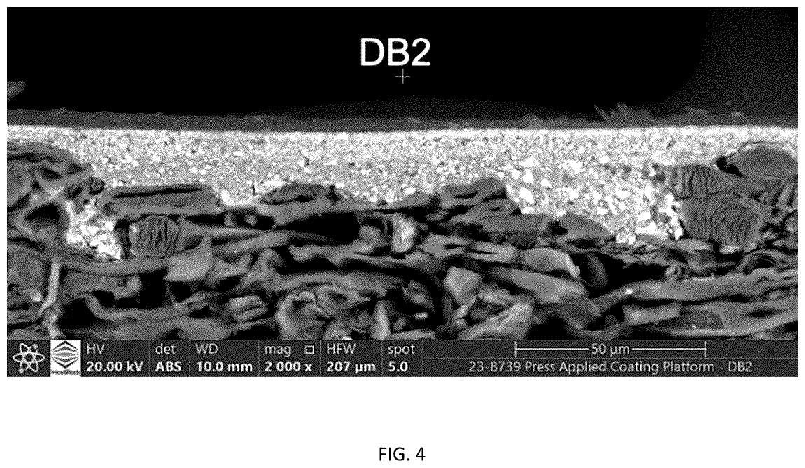

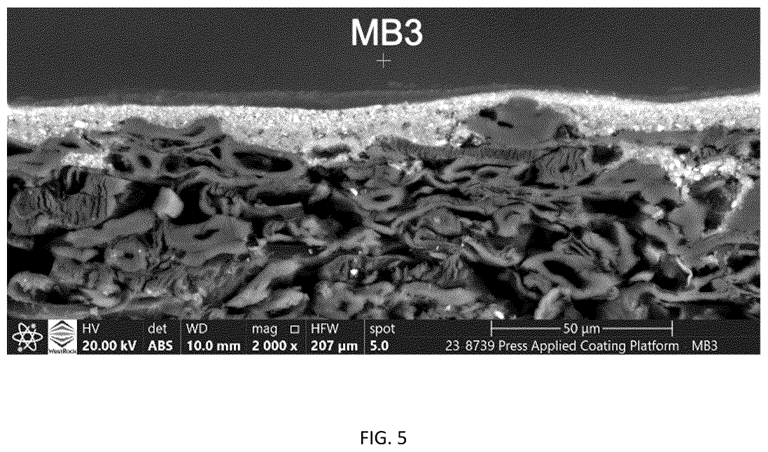

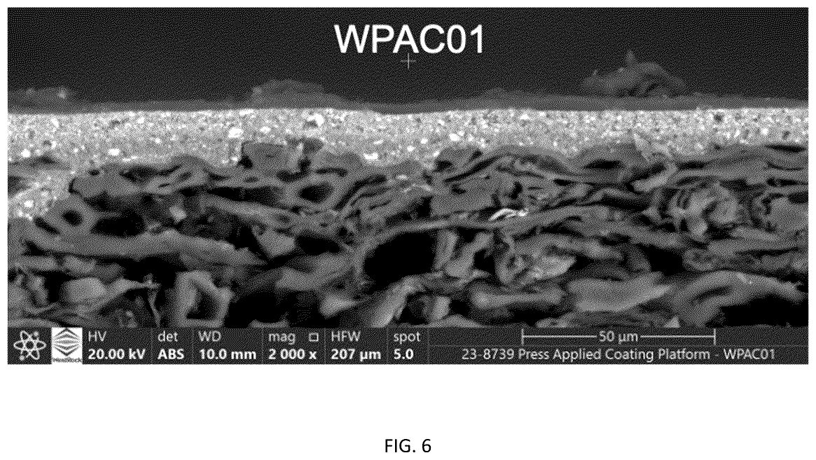

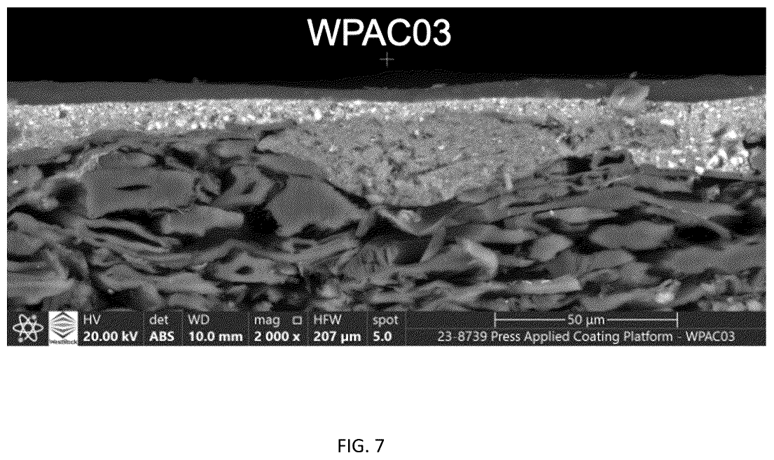

The quantitative data from Tables 1 and 2 are complemented by Scanning Electron Microscope (SEM) images that vividly illustrate the surface morphology of the barrier coatings. For the samples processed with extended heat (DB2, MB3, WPAC01, and WPAC03), SEM images (FIGS. 4-7) display the formation of a continuous, uniform film, validating the effectiveness of the elevated temperature in creating a consistent and reliable barrier layer.

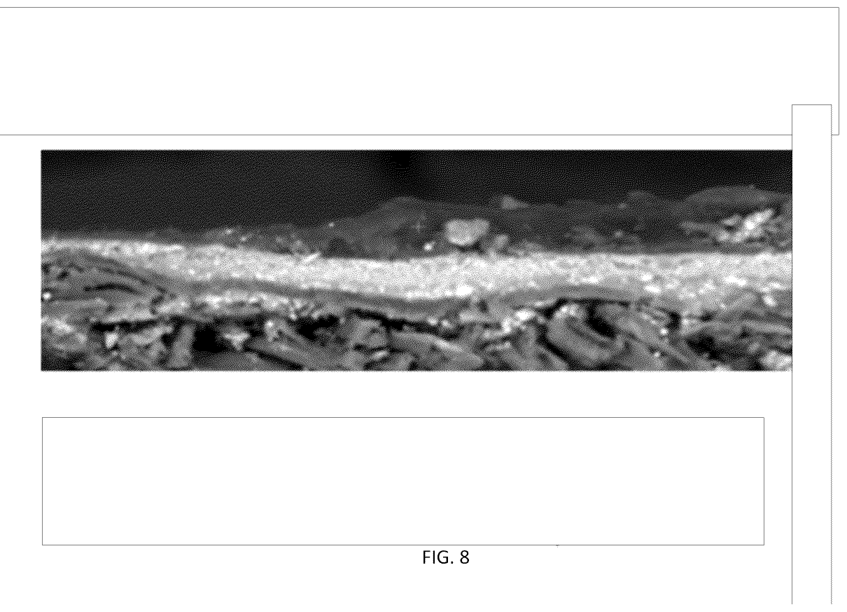

In contrast, the SEM image of the comparative example (FIG. 8) reveals a lack of uniformity in the barrier coating. This image clearly shows areas where the barrier material did not form a continuous layer, confirming the observations made during the comparative trial that led to the conclusion of inadequate barrier formation at the lower temperature of 180 degrees Fahrenheit.

### 7.3 Analysis of Experimental Results

The analysis of the experimental results underscores the efficacy of elevated heating temperatures in enhancing the uniformity and barrier properties of the coated paperboard. All experimental examples, irrespective of the variations in temperature settings and press speeds, demonstrate a marked improvement in WVTR when the heating temperature exceeded 200 degrees Fahrenheit, and the web temperature exceeded 120 degrees Fahrenheit. WPAC03 shows that dwell time is another important factor, where 2 seconds of dwell time results in WVTR of 494 even dryer temperature of 250 and web surface temperature of 136 F. Therefore, dwell time and web temperature may be balanced to achieve a more uniformly covered barrier coating on top of basecoated cellulosic structure.

This improvement is significant when contrasted with the comparative example, which utilized a drying temperature of 180 degrees Fahrenheit and resulted in inadequate barrier application, including areas with completely absent barrier material. The consistent performance across a range of operational conditions supports the concept that elevated heating is an important factor in ensuring the quality and effectiveness of the barrier layer.

The data collectively indicate that elevated heating temperatures are significant for achieving a reliable and robust barrier coating, as lower temperatures do not provide the same level of material adhesion and uniformity. This principle holds true across various operational settings, confirming that the process is adaptable and can maintain high-quality results despite differing production parameters.

The SEM images serve as a visual confirmation of the experimental findings discussed. They provide a stark comparison between the successful application of the barrier layer under optimal conditions and the deficient application observed in the comparative example. The analysis further underscores the importance of extended heat in the manufacturing process to achieve the desired barrier properties.

Although various embodiments of the disclosed structures and methods have been shown and described, modifications may occur to those skilled in the art upon reading the specification. The present application includes such modifications and is limited only by the scope of the claims.

What is claimed is:

1. A coated cellulosic structure, comprising:
a cellulosic sheet substrate;
a basecoat layer on the cellulosic sheet substrate; and
a barrier layer on the basecoat layer, wherein the barrier layer has an average thickness (AT) in a range of from about 1 μm to about 6 μm, and wherein the barrier layer has a uniformity in thickness characterized by a coefficient of variation (CV) of 0.7 or less, wherein CV=σ/AT, wherein σ is a standard deviation of the thickness.

2. The coated cellulosic structure of claim 1, wherein the cellulosic sheet substrate comprises bleached fibers.

3. The coated cellulosic structure of claim 1, wherein the cellulosic sheet substrate comprises natural kraft fibers.

4. The coated cellulosic structure of claim 1, wherein the cellulosic sheet substrate comprises recycled fibers.

5. The coated cellulosic structure of claim 1, wherein the cellulosic sheet substrate has a thickness ranging from about 6 to about 36 points.

6. The coated cellulosic structure of claim 1, wherein the basecoat layer comprises a polymer binder and mineral pigments.

7. The coated cellulosic structure of claim 6, wherein the basecoat layer comprises a binder to pigment ratio ranging from about 12 to about 50 parts binder to 100 parts pigment.

8. The coated cellulosic structure of claim 1, wherein the barrier layer comprises an aqueous based formulation.

9. The coated cellulosic structure of claim 8, wherein the aqueous based formulation comprises at least one of a polymer latex, a polymer dispersion, and a polymer emulsion.

10. The coated cellulosic structure of claim 8, wherein the barrier layer comprises pigments.

11. The coated cellulosic structure of claim 10, wherein the pigments in the barrier layer comprise at least one of clay and calcium carbonate.

12. The coated cellulosic structure of claim 10, wherein the barrier layer comprises a binder to pigment ratio ranging from about 150 to about 900 parts binder to 100 parts pigment.

13. The coated cellulosic structure of claim 1, wherein the coated cellulosic structure further comprises a second layer of the barrier coating.

14. The coated cellulosic structure of claim 1, wherein the barrier layer is applied to achieve a Water Vapor Transmission Rate (WVTR) of less than 400 grams/m²/day at 38° C. and 90% RH.

15. The coated cellulosic structure of claim 1, wherein the barrier layer provides an Oil and Grease Resistance (OGR) meeting a Kit level of at least 12.

16. A method for applying a barrier layer to a basecoated cellulosic structure, the method comprising:
transferring a barrier material to a roller having cells for holding a predetermined volume of the barrier material;
transferring the barrier material from the roller having cells to a transfer roller;
applying the barrier material from the transfer roller to a basecoat layer on a cellulosic sheet substrate to form a barrier layer; and
drying the applied barrier layer at a drying temperature of 200 degrees F. or greater for a time sufficient to achieve a web surface temperature of 120 degrees F. or greater.

17. The method of claim 16, wherein the applied barrier layer is at the drying temperature for at least 6 seconds.

18. The method of claim 16, wherein the drying temperature is in a range of 200 to 350 degrees Fahrenheit.

19. The method of claim 16, wherein the web surface temperature is in a range of 120 to 180 degrees Fahrenheit.

20. (canceled)

21. (canceled)

22. (canceled)

23. (canceled)

24. A method for manufacturing a coated cellulosic structure, the method comprising:
providing a cellulosic sheet substrate;
applying a basecoat layer on the cellulosic sheet substrate; and
applying a barrier layer on the basecoat layer, wherein applying the barrier layer comprises:
transferring a barrier material to a roller having cells for holding a predetermined volume of the barrier material;
transferring the barrier material from the roller having cells to a transfer roller;
applying the barrier material from the transfer roller to the basecoat layer to form a barrier layer;
drying the applied barrier layer at a drying temperature of 200 degrees F. or greater for a time sufficient to achieve a web surface temperature of 120 degrees F. or greater.
